(19) United States
(12) Patent Application Publication
(10) Pub. No.: US 2009/0276701 A1
(43) Pub. Date: Nov. 5, 2009

(54) APPARATUS, METHOD AND COMPUTER PROGRAM PRODUCT FOR FACILITATING DRAG-AND-DROP OF AN OBJECT

(75) Inventor: Mikko A. Nurmi, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/112,625

(22) Filed: Apr. 30, 2008

(51) Int. Cl. G06F 3/041; G06F 3/048

(52) U.S. Cl. 715/702; 715/765

(57) ABSTRACT

An apparatus, method and computer program product are provided for facilitating the drag-and-drop of an object, wherein the distance a user has to drag a graphical item associated with the object may be reduced. Once a user has selected an object, for which a graphical item is displayed on an electronic device display screen, the electronic device may attempt to predict with which target object the user is likely to link, or otherwise associate, the selected object. Once the electronic device has identified one or more potential target objects, the electronic device may cause the graphical item(s) associated with those potential target object(s) to be displayed on the electronic device display screen at a location that is close to the location at which the selected graphical item is displayed.

### FIELD

Embodiments of the invention relate, generally, to the manipulation of objects stored on an electronic device and, in particular, to an improved “drag-and-drop” technique for manipulating those objects.

### BACKGROUND

A common way of manipulating objects stored on or associated with an electronic device (e.g., cellular telephone, personal digital assistant (PDA), laptop, personal computer, etc.) is to “drag-and-drop” those objects. In particular, in order to drag-and-drop an object, a user may first select a graphical item displayed on the electronic device display screen that is associated with the object, drag the graphical item to a new location, and then un-select the graphical item. When a first object is dragged and dropped on a second object (i.e., when the first graphical item is selected at a first location, dragged, and then unselected at a second location at which the second graphical item is displayed), an action may be taken in association with the two objects, wherein the action is dependent upon the types of objects being manipulated (e.g., text, audio, video or multimedia files, applications, functions, actions, etc.).

For example, dragging and dropping a text file onto a folder in the electronic device's memory (e.g., by dragging the graphical item or icon associated with the text file to the location at which the graphical item associated with the folder is displayed and then dropping it) may result in the text file being moved from its current location in the electronic device's memory to inside the folder. In contrast dragging and dropping an audio file onto a music player application may cause the music player application to launch and output the dragged audio file.

Dragging and dropping of objects may be done using a touch-sensitive display screen, or touchscreen, wherein the user physically touches the touchscreen, using his or her finger, stylus or other selection device, at the location where the first graphical item is displayed, moves the selection device across the touchscreen to the location where the second graphical item is displayed, and then lifts the selection device from the touchscreen in order to “drop” the first object onto the second object. Alternatively, a touchpad or mouse may be used to select, drag and drop objects for which graphical items are displayed on a non-touch sensitive display screen.

In either case, the distance on the display screen that the graphical item needs to be dragged in order to be dropped on the second graphical item may be quite long. This may result in problems, particularly where a user is attempting to use only one hand to drag items displayed on a touchscreen, or where a relatively small touchpad or mouse pad is used in conjunction with a relatively large display screen.

A need, therefore, exists for a way to improve a user's drag-and-drop experience.

### BRIEF SUMMARY

In general, embodiments of the present invention provide an improvement by, among other things, providing an improved drag-and-drop technique that reduces the distance a user has to drag the graphical item associated with a selected object (“the selected graphical item”) in order to drop the selected graphical item onto a graphical item associated with a target object (“the target graphical item”). In particular, according to one embodiment, one or more potential target objects may be determined, for example, based on the ability of the selected object to be somehow linked to the target object(s) and/or the likelihood that the user desires to link the selected object with the target object(s). The graphical items associated with the identified potential target objects may thereafter be moved on the electronic device display screen so that they are displayed at a location that is closer to the selected graphical item.

In accordance with one aspect, an apparatus is provided for facilitating drag-and-drop of an object. In one embodiment, the apparatus may include a processor that is configured to: (1) receive a selection of an object; (2) identify one or more potential target objects with which the selected object is linkable; and (3) alter an image on a display screen so as to cause a graphical item associated with at least one of the one or more identified potential target objects to be displayed within a predefined distance from a first location at which either a graphical item associated with the selected object is displayed within the image or a key associated with the selected object is located within a keypad of the apparatus.

In accordance with another aspect, a method is provided for facilitating drag-and-drop of an object. In one embodiment, the method may include: (1) receiving a selection of an object; (2) identifying one or more potential target objects with which the selected object is linkable; and (3) altering an image on a display screen so as to cause a graphical item associated with at least one of the one or more identified potential target objects to be displayed within a predefined distance from a first location at which either a graphical item associated with the selected object is displayed within the image or a key associated with the selected object is located within a keypad.

According to yet another aspect, a computer program product is provided for facilitating drag-and-drop of an object. The computer program product contains at least one computer-readable storage medium having computer-readable program code portions stored therein. The computer-readable program code portions of one embodiment may include: (1) a first executable portion for receiving a selection of an object; (2) a second executable portion for identifying one or more potential target objects with which the selected object is linkable; and (3) a third executable portion for altering an image on a display screen so as to cause a graphical item associated with at least one of the one or more identified potential target objects to be displayed within a predefined distance from a first location at which either a graphical item associated with the selected object is displayed within the image or a key associated with the selected object is located within a keypad.

According to another aspect, an apparatus is provided for facilitating drag-and-drop of an object. In one embodiment, the apparatus may include: (1) means for receiving a selection of an object; (2) means for identifying one or more potential target objects with which the selected object is linkable; and (3) means for altering an image on a display screen so as to cause a graphical item associated with at least one of the one or more identified potential target objects to be displayed within a predefined distance from a first location at which either a graphical item associated with the selected object is displayed within the image or a key associated with the selected object is located within a keypad of the apparatus.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an entity capable of operating as an electronic device configured to provide the drag-and-drop technique in accordance with embodiments of the present invention;

FIG. 2 is a schematic block diagram of a mobile station capable of operating in accordance with an embodiment of the present invention;

FIG. 3 is a flow chart illustrating the operations that may be performed in order to facilitate drag-and-drop of an object in accordance with embodiments of the present invention; and

FIGS. 4-7B illustrate the process of facilitating drag-and-drop of an object in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, method and computer program product for facilitating the drag-and-drop of an object (e.g., text, audio, video or multimedia file, application, function, action, etc.), wherein the distance a user has to drag a graphical item (e.g., icon) associated with the object may be reduced. In particular, according to one embodiment, once a user has selected an object, for which a graphical item is displayed on an electronic device display screen (“the selected graphical item”), the electronic device (e.g., cellular telephone, personal digital assistant (PDA), laptop, personal computer, etc) may attempt to predict with which target object the user is likely to link, or otherwise associate, the selected object.

For example, if the user has selected a word document, the electronic device may predict that the user may desire to link the word document with a particular folder in the electronic device's memory (i.e., to move the word document from its current location in memory to within the particular folder). Alternatively, if the user has selected a v-card, or a digital business card including contact information associated with a particular individual or company, the electronic device may predict that the user may desire to link the v-card to a messaging application (e.g., causing an email, short message service (SMS) or multimedia message service (MMS) message, or the like, to be launched that is addressed to the address included in the v-card).

Once the electronic device has identified one or more potential target objects, the electronic device may cause the graphical item(s) associated with those potential target object(s) (“the target graphical items”) to be displayed on the electronic device display screen at a location that is close to the location at which the selected graphical item is displayed. This may involve moving a previously displayed potential target graphical item to a location that is closer to the selected graphical item than its original location. Alternatively, it may involve first generating then displaying a potential target graphical item that was not previously displayed and/or visible on the electronic device display screen. In another embodiment, the electronic device may cause the potential target graphical item(s) to expand or enlarge, such that the graphical item(s) are, in effect, closer to the selected graphical item and, therefore, more easily linked to the selected graphical item.

By ensuring that the graphical items associated with the target objects with which the user is likely to link, or otherwise associate, the selected object are close to the selected graphical item, embodiments of the present invention may reduce the distance a user has to drag the selected graphical item, as well as highlight the potential target objects, thereby improving his or her drag-and-drop experience.

### Electronic Device:

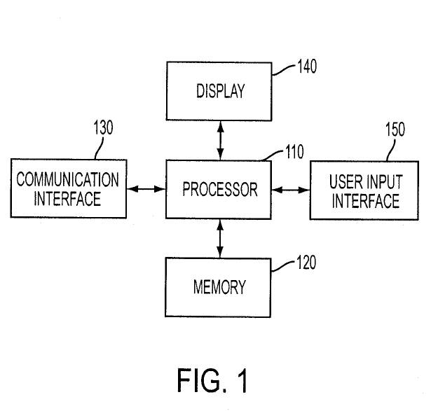

Referring to FIG. 1, a block diagram of an electronic device (e.g., cellular telephone, personal digital assistant (PDA), laptop, etc.) configured to facilitate drag-and-drop of an object in accordance with embodiments of the present invention is shown. The electronic device may include various means for performing one or more functions in accordance with embodiments of the present invention, including those more particularly shown and described herein. It should be understood, however, that one or more of the electronic devices may include alternative means for performing one or more like functions, without departing from the spirit and scope of the present invention. As shown, the electronic device may generally include means, such as a processor 110 for performing or controlling the various functions of the electronic device.

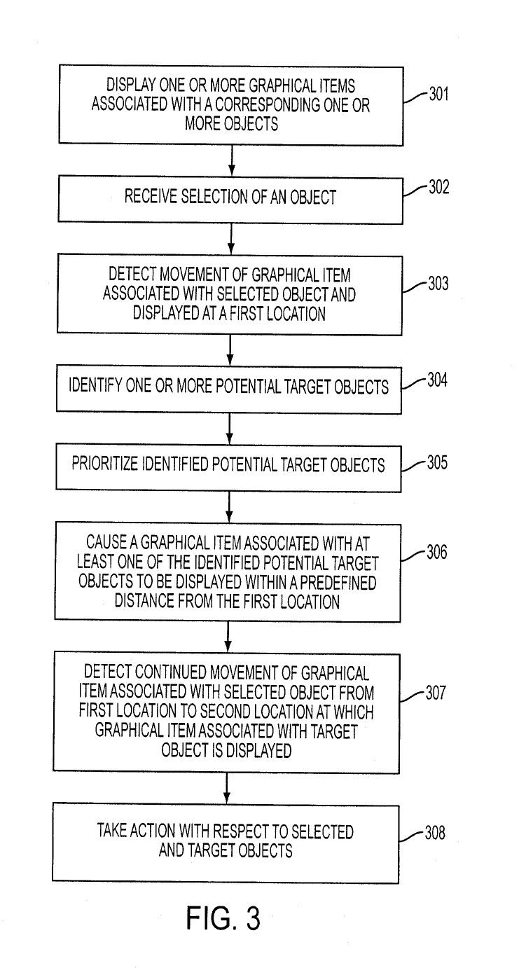

In particular, the processor 110, or similar means, may be configured to perform the processes discussed in more detail below with regard to FIG. 3. For example, according to one embodiment, the processor 110 may be configured to receive a selection of an object having a corresponding graphical item displayed at a first location within an image on a display screen of the electronic device and to detect a movement of the graphical item from the first location in a first direction. The processor 110 may further be configured to identify one or more potential target objects with which the selected object is linkable, and to alter the image so as to cause a graphical item associated with at least one of the one or more identified potential target objects to be displayed within a predefined distance from the first location.

In one embodiment, the processor 110 may be in communication with or include memory 120, such as volatile and/or non-volatile memory that stores content, data or the like. For example, the memory 120 may store content transmitted from, and/or received by, the electronic device. Also for example, the memory 120 may store software applications, instructions or the like for the processor to perform steps associated with operation of the electronic device in accordance with embodiments of the present invention. In particular, the memory 120 may store software applications, instructions or the like for the processor to perform the operations described above and below with regard to FIG. 3 for facilitating drag-and-drop of an object.

For example, according to one embodiment, the memory 120 may store one or more modules for instructing the processor 110 to perform the operations including, for example, a motion detection module, a potential target identification module, and a repositioning module. In one embodiment, the motion detection module may be configured to receive a selection of an object having a corresponding graphical item displayed at a first location within an image on a display screen of the electronic device and to detect a movement of the graphical item from the first location in a first direction. The potential target identification module may be configured to identify one or more potential target objects with which the selected object is linkable. Finally, the repositioning module may be configured to alter the image so as to cause a graphical item associated with at least one of the one or more identified potential target objects to be displayed within a predefined distance from the first location.

In addition to the memory 120, the processor 110 can also be connected to at least one interface or other means for displaying, transmitting and/or receiving data, content or the like. In this regard, the interface(s) can include at least one communication interface 130 or other means for transmitting and/or receiving data, content or the like, as well as at least one user interface that can include a display 140 and/or a user input interface 150. The user input interface, in turn, can comprise any of a number of devices allowing the electronic device to receive data from a user, such as a keypad, a touchscreen or touch display, a joystick or other input device.

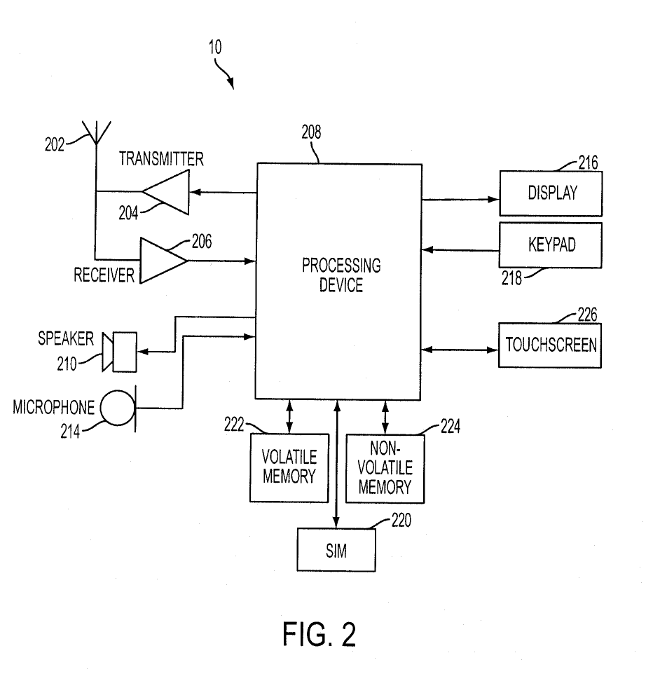

Reference is now made to FIG. 2, which illustrates one specific type of electronic device that may benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station may include various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 2, in addition to an antenna 202, the mobile station 10 may include a transmitter 204, a receiver 206, and an apparatus that includes means, such as a processor 208, controller or the like, that provides signals to and receives signals from the transmitter 204 and receiver 206, respectively, and that performs the various other functions described below including, for example, the functions relating to providing an input gesture indicator.

As discussed above with regard to FIG. 2 and in more detail below with regard to FIG. 3, in one embodiment, the processor 208 may be configured to receive a selection of an object having a corresponding graphical item displayed at a first location within an image on a display screen of the mobile station and to detect a movement of the graphical item from the first location in a first direction. The processor 208 may further be configured to identify one or more potential target objects with which the selected object is linkable, and to alter the image so as to cause a graphical item associated with at least one of the one or more identified potential target objects to be displayed within a predefined distance from the first location.

As one of ordinary skill in the art would recognize, the signals provided to and received from the transmitter 204 and receiver 206, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processor 208, controller or other computing device, may include the circuitry required for implementing the video, audio, and logic functions of the mobile station and may be capable of executing application programs for implementing the functionality discussed herein. For example, the processor may be comprised of various means including a digital signal processor device, a microprocessor device, and various analog to digital converters, digital to analog converters, and other support circuits. The control and signal processing functions of the mobile device are allocated between these devices according to their respective capabilities. The processor 208 thus also includes the functionality to convolutionally encode and interleave message and data prior to modulation and transmission. The processor can additionally include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214, a display 316, all of which are coupled to the processor 208. The user input interface, which allows the mobile device to receive data, can comprise any of a number of devices allowing the mobile device to receive data, such as a keypad 218, a touch-sensitive input device, such as a touchscreen or touchpad 226, a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs.

For example, in one embodiment of the present invention, the memory may store computer program code for facilitating drag-and-drop of an object. In particular, according to one embodiment, the memory may store the motion detection module, the potential target identification module, and the repositioning module described above with regard to FIG. 2

The apparatus, method and computer program product of embodiments of the present invention are primarily described in conjunction with mobile communications applications. It should be understood, however, that the apparatus, method and computer program product of embodiments of the present invention can be utilized in conjunction with a variety of other applications, both in the mobile communications industries and outside of the mobile communications industries. For example, the apparatus, method and computer program product of embodiments of the present invention can be utilized in conjunction with wireline and/or wireless network (e.g., Internet) applications.

### Method of Facilitating Drag-and-Drop of an Object

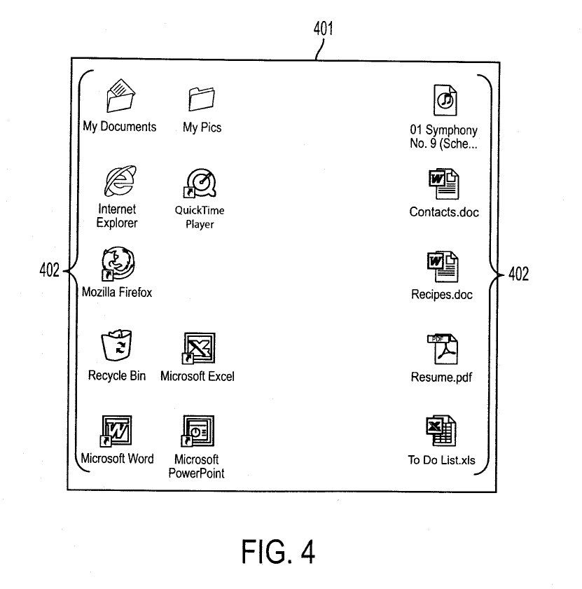

Referring now to FIG. 3, the operations are illustrated that may be taken in order to facilitate drag-and-drop of an object in accordance with embodiments of the present invention. Reference will also be made throughout the following description to FIGS. 4-7B which provide several illustrations of the process for facilitating drag-and-drop of an object in accordance with embodiments of the present invention. As shown in FIGS. 3 and 4, the process may begin at Block 301 when one or more graphical items 402 associated with a corresponding one or more objects are displayed on an electronic device display screen 401. As noted above, the objects may include, for example, text, audio, video or multimedia files, applications, or the like, stored on or accessible by the electronic device. The objects may further include one or more functions or actions capable of being performed by the electronic device including, for example, to open, send, view, or the like, another object stored on or accessible by the electronic device. As further noted above, the display screen 401 may comprise a touchscreen or a non-touch sensitive display screen operative in conjunction with a touch- or mouse pad.

At some point thereafter, a user may desire to “drag-and-drop” one of the objects for which a graphical item 402 is displayed on the display screen 401 onto another object, which may or may not have a corresponding graphical item currently displayed and/or visible on the electronic device display screen 401. As discussed above, when a first object (“the selected object”) is dragged and dropped onto a second object (“the target object”) an action may be taken in association with the two objects, wherein the action may be dependent upon the objects and/or the types of objects being manipulated. For example, dragging and dropping a text file onto a folder in the electronic device's memory may result in the text file being moved from its current location in the electronic device's memory to inside the folder, while dragging and dropping an audio file onto a music player application may cause the music player application to launch and output the dragged audio file.

When the user determines that he or she desires to drag-and-drop a particular object, he or she may first select the graphical item 402 that is associated with that object and is displayed on the electronic device display screen 401 at a first location. The user may thereafter “drag,” or otherwise cause the selected graphical item to move away from the first location on the electronic device display screen 401. The electronic device, and in particular a means, such as a processor and, in one embodiment, the motion detection module, may receive the selection of the object and detect the movement of the graphical item associated with the selected object at Blocks 302 and 303, respectively.

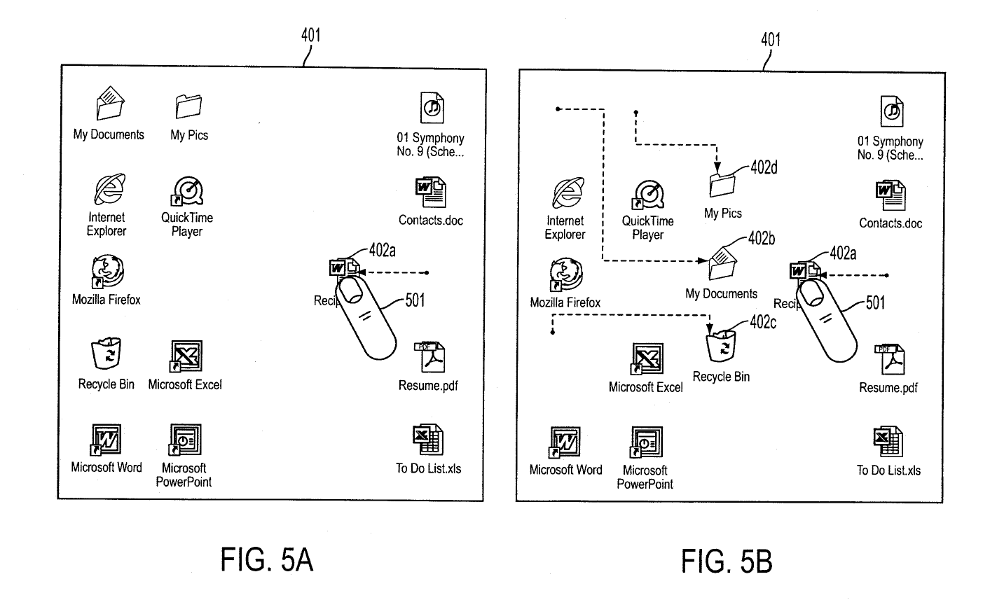

As shown in FIG. 5A, in one embodiment, wherein the electronic device display screen 401 is a touchscreen, the user may use his or her finger 501, or other selection device (e.g., pen, stylus, pencil, etc.), to select the object and move the corresponding graphical item 402a. The electronic device (e.g., means, such as the processor and, in one embodiment, the motion detection module) may detect the tactile inputs associated with the selection and movement and determine their location via any number of techniques that are known to those of ordinary skill in the art. For example, the touchscreen may comprise two layers that are held apart by spacers and have an electrical current running there between. When a user touches the touchscreen, the two layers may make contact causing a change in the electrical current at the point of contact. The electronic device may note the change of the electrical current, as well as the coordinates of the point of contact.

Alternatively, wherein the touchscreen uses a capacitive, as opposed to a resistive, system to detect tactile input, the touchscreen may comprise a layer storing electrical charge. When a user touches the touchscreen, some of the charge from that layer is transferred to the user causing the charge on the capacitive layer to decrease. Circuits may be located at each corner of the touchscreen that measure the decrease in charge, such that the exact location of the tactile input can be calculated based on the relative differences in charge measured at each corner. Embodiments of the present invention can employ other types of touchscreens, such as a touchscreen that is configured to enable touch recognition by any of resistive, capacitive, infrared, strain gauge, surface wave, optical imaging, dispersive signal technology, acoustic pulse recognition or other techniques, and to then provide signals indicative of the location of the touch.

The touchscreen interface may be configured to receive an indication of an input in the form of a touch event at the touchscreen. As suggested above, the touch event may be defined as an actual physical contact between a selection device (e.g., a finger, stylus, pen, pencil, or other pointing device) and the touchscreen. Alternatively, a touch event may be defined as bringing the selection device in proximity to the touchscreen (e.g., hovering over a displayed object or approaching an object within a predefined distance).

As noted above, however, embodiments of the present invention are not limited to use with a touchscreen or touch display. As one of ordinary skill in the art will recognize, a non-touch sensitive display screen may likewise be used without departing from the spirit and scope of embodiments of the present invention. In addition, while the foregoing description, as well as FIG. 5A, illustrate the selected graphical item being moved as the user drags his or her finger across the display screen or, likewise, as he or she moves a cursor across the display screen using, for example, a mouse or a touchpad, embodiments of the present invention are not limited to this particular scenario. In particular, according to one embodiment, the electronic device (e.g., means, such as a processor and, in one embodiment, the motion detection module) may detect the movement of the user's finger/cursor without causing a resulting movement of the selected graphical item.

In response to receiving the selection and detecting movement of the user's finger (i.e., tactile input)/cursor and, in one embodiment, the selected graphical item, the electronic device (e.g., means, such as a processor and, in one embodiment, the potential target identification module) may, at Block 304, identify one or more potential target objects with which the user may desire to link, or otherwise associate, the selected object. While not shown, in one embodiment, the electronic device (e.g., means, such as a processor and, in one embodiment, the potential target identification module) may identify the potential target objects in response to receiving the selection of the object, but prior to the detection of the movement of the tactile input/cursor. In either embodiment, the electronic device may identify the one or more potential target objects based on any number and combination of factors. For example, according to one embodiment, the electronic device (e.g., means, such as a processor and, in one embodiment, the potential target identification module) may identify all objects with which the selected object could be linked, or otherwise associated—i.e., excluding only those with which it would not be possible or feasible to link the selected object. For example, if the user selected a PowerPoint presentation, the potential target objects may include memory folders and the PowerPoint application, but not an Internet browser application. In one embodiment, in order to identify all possible target objects, the electronic device (e.g., means, such as a processor and, in one embodiment, the potential target identification module) may access a look up table (LUT) that is either stored locally on the electronic device or accessible by the electronic device and includes a mapping of each object or object type to the related objects or object types with which the object could be linked, or otherwise associated.

In another embodiment, the electronic device (e.g., means, such as a processor and, in one embodiment, the potential target identification module) may identify potential target objects based on the direction of the movement of the tactile input/cursor. For example, if the user moved his or her finger and/or the cursor to the left, all objects having a corresponding graphical item displayed to the left of the selected graphical item may be identified as potential target objects, while those having a corresponding graphical item displayed to the right of the selected graphical item may not be.

In yet another embodiment, the electronic device (e.g., means, such as a processor and, in one embodiment, the potential target identification module) may identify potential target objects based on past linkages or associations preformed by the user with respect to the selected object. In particular, the electronic device (e.g., means, such as a processor and, in one embodiment, the potential target identification module) may store historical data regarding the selections and linkages/associations performed by the user over some predefined period of time. The electronic device may then use this information to predict, based on the selected object, what are the most likely target object(s). For example, if in the past year, 75% of the time the user selected a particular audio file, he or she dragged that audio file to the music player application executing on the electronic device (i.e., the user linked the audio file to the music player application), the electronic device (e.g., means, such as a processor and, in one embodiment, the potential target identification module) may identify the music player application as a potential target object the next time the user selects that audio file.

Assuming the electronic device (e.g., means, such as a processor and, in one embodiment, the potential target identification module) identifies more than one potential target object, which is not necessarily the case, according to one embodiment, the electronic device may, at Block 305, prioritize the identified potential target objects based on the likelihood that each is the desired target object of the user. In one embodiment, prioritization may be based, for example, on an analysis of the historical information gathered. For example, if in the past month a user dragged a selected object to a first target object 40% of the time, while dragging the selected object to a second target object 60% of the time, the second target object may be prioritized over the first. In another embodiment, the direction of movement of the tactile input/cursor may be used to prioritize potential target objects that have been identified, for example, simply because the selected object is capable of being linked, or otherwise associated, with those objects. For example, if three potential target objects were identified at Block 304 as capable of being linked to the selected object, but only one has a graphical item that is displayed in the direction of movement of the tactile input/cursor, the potential target object having the graphical item displayed in the direction of movement may be prioritized over the other potential target objects.

In one exemplary embodiment, the user may define rules for identifying and/or prioritizing potential target objects. For example, the user may indicate that the number of identified potential target objects should not exceed some maximum threshold (e.g., three). Similarly, the user may specify that in order to be identified, at Block 302, as a potential target object, the probability that the object is the target object must exceed some predefined threshold (e.g., 30%).

As one of ordinary skill in the art will recognize, the foregoing techniques described for both identifying and prioritizing potential target objects may be used in any combination in accordance with embodiments of the present invention. For example, the potential target objects may be identified based on the user's direction of movement and then prioritized based on historical information. Alternatively, the potential target objects may be identified based on historical information and then prioritized based on the user's direction of movement. Other, similar, combinations including the techniques described above, as well as additional techniques not described, exist and should be considered within the scope of embodiments of the present invention.

Once the potential target object(s) have been identified and, where applicable and desired, prioritized, the electronic device (e.g., means, such as a processor and, in one embodiment, the repositioning module) may, at Block 306, cause a graphical item associated with at least one of the identified potential target objects (“the potential target graphical item”) to be displayed within a predefined distance from the first location, at which the selected graphical item is displayed. In particular, according to embodiments of the present invention, the electronic device may cause at least one potential target graphical item to be displayed at a location that is relatively close to the location of the selected graphical item, so that in order to link the selected object with the target object, the user need only drag the selected graphical item a short distance. As one of ordinary skill in the art will recognize, the predefined distance may vary based on the size of the display screen. For instance, the predefined distance associated with a relatively large display screen may be further than that associated with a relatively small display screen.

As above wherein the user may define rules for identifying and prioritizing potential target objects, the user may further define rules for whether and how the corresponding potential target graphical items will be displayed. For example, in one exemplary embodiment, the user may define the number of potential target graphical items he or she desires to have displayed within the predefined distance from the selected graphical item (e.g., only four, or only those having a probability of more than 30%). In another embodiment, the user may define the manner in which those potential target graphical items should be displayed (e.g., the predefined distance, or how far or how close to the selected graphical item).

In one embodiment, the potential target graphical item may have been previously displayed on the electronic device display screen (e.g., at a second location). In this embodiment, display of the potential target graphical item within a predefined distance from the location of the selected graphical item (e.g., at the first location) may involve translating the previously displayed potential target graphical item, such that it is moved from its original location (e.g., the second location) to a third location that is closer to the location of the selected graphical item. Alternatively, or in addition, display of the potential target object within the predefined distance may involve enlarging or expanding the potential target object on the display screen, such that the expanded potential target object is, in effect, closer to the selected graphical item.

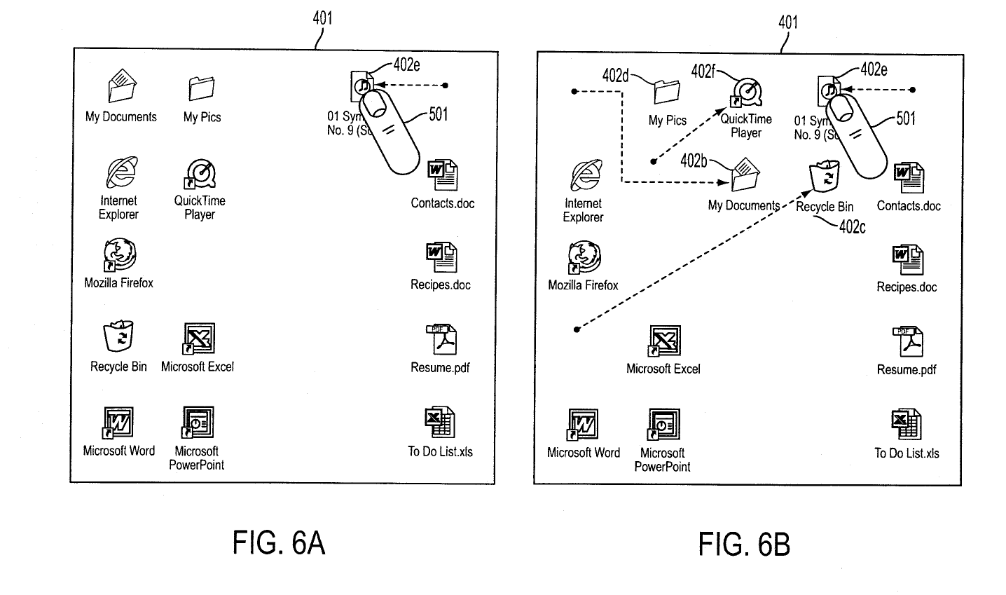

To illustrate, reference is made to FIGS. 5B-6B. As shown in FIG. 5B, the user has selected the graphical item 402a associated with a word document entitled “Recipes” and then moved the selected graphical item 402a using his or her finger 501 across the electronic device touchscreen 401. In response, the electronic device (e.g., means, such as a processor and, in one embodiment, the potential target identification module) identified, at Block 304, three potential target objects, namely memory folders entitled “My Pics” and “My Documents,” and the Recycle Bin. According to one embodiment, the electronic device (e.g., means, such as a processor and, in one embodiment, the repositioning module) may then move the graphical items 402b, 402c and 402d associated with these potential target objects from their original display location to locations that are closer to the selected graphical item 402a.

Similarly, referring to FIGS. 6A and 6B, when the user selected and moved the graphical item 402e associated with an audio file entitled “01 Symphony No. 9,” the electronic device (e.g., means, such as a processor and, in one embodiment, the potential target identification module) of this embodiment identified, at Block 304, four potential target objects, namely the My Pics and My Documents memory folders, the Recycle Bin and a music player application (e.g., QuickTime Player). According to embodiments of the present invention, the electronic device (e.g., means, such as a processor and, in one embodiment, the repositioning module) may thereafter cause the graphical items 402b, 402c, 402d and 402f associated with the identified potential target objects to be moved closer to the selected graphical item 402e associated with the audio file. As shown in the embodiment of FIG. 6B, where the graphical item associated with one of the identified potential target objects (e.g., target graphical item 402d associated with the memory folder My Pics) is already close to (e.g., within a predefined distance from) the selected graphical item 402e, it may not be necessary for the electronic device to move that graphical item.

In one embodiment, each potential target graphical item may be moved to within a different distance from the selected graphical item depending upon its relative priority, as determined at Block 305. For example, in one embodiment, potential target graphical items having a high priority relative to other potential target graphical items may be moved closer to the selected graphical item. This is also illustrated in FIGS. 5B and 6B. For example, referring to FIG. 6B, the electronic device may have determined, at Block 305, that it was more likely that the user would drag the selected audio file (associated with graphical item 402e) to the My Documents memory folder, the Recycle Bin or the music player application, than to the My Pics memory folder. As a result, the electronic device (e.g., means, such as a processor and, in one embodiment, the repositioning module) may cause the graphical items 402b, 402c, and 402f associated with the My Documents memory folder, the Recycle Bin and the music player application, respectively, to be displayed at a location that is closer to the selected graphical item 402e than the graphical item 402d associated with the My Pics memory folder.

Embodiments of the present invention are not, however, limited to previously displayed potential target graphical items. In particular, several instances may arise where a potential target object does not have a corresponding graphical item currently visible on the electronic device display screen. For example, the electronic device may include a scrollable display screen that is currently scrolled to display an area in which the potential target graphical item is not currently located, or the potential target graphical item may be visible on a different screen than that on which the selected graphical item is visible. Alternatively, the potential target object may not have a graphical item associated with it at all. In yet another example, an object currently displayed on the electronic device display screen may be obscuring the potential target graphical item. For example, a word document may be opened on the electronic device display screen, wherein the document obscures some portion, but not all, of the electronic device display screen including the area on which the potential target graphical item is displayed.

In the instance where, for whatever reason, the potential target graphical item is not currently displayed or visible on the electronic device display screen, causing the potential target graphical item to be displayed within a predefined distance from the selected graphical item may involve first generating the potential target graphical item and then causing it to be displayed at the desired location.

Returning to FIG. 3, at some point thereafter, the user may continue to drag the selected target object to the actual desired target object (i.e., by movement of his or her finger and/or the cursor), which may or may not be one of the potential target objects identified by the electronic device at Block 304. In particular, the user may move the his or her finger/cursor from the first location on the electronic device display screen to a second location at which the graphical item associated with the actual target object is displayed. Assuming the actual desired target object was one of the potential target objects identified, this movement should be less burdensome for the user.

The electronic device (e.g., means, such as a processor operating thereon) may detect the movement, at Block 307, as well as the release of the selected object, and, in response, take some action with respect to the selected and target objects (at Block 308). As noted above, the action taken by the electronic device may depend upon the selected and target objects and their corresponding types. In order to, therefore, determine the action that is taken, according to one embodiment, the electronic device may access a LUT including a mapping of each object and/or object type pairing to the action that should be taken with respect to those objects and/or object types. For example, as noted above, dragging a v-card onto a message application may result in a message (e.g., email, SMS or MMS message, etc.) being launched that is addressed to the address of the v-card, whereas dragging an Excel spreadsheet to the Recycle Bin may cause the spreadsheet to be deleted from the electronic device's memory. As one of ordinary skill in the art will recognize, countless examples exist for pairings of objects and the resulting action that is taken. The foregoing examples are, therefore, provided for exemplary purposes only and should not in any way be taken as limiting the scope of embodiments of the present invention.

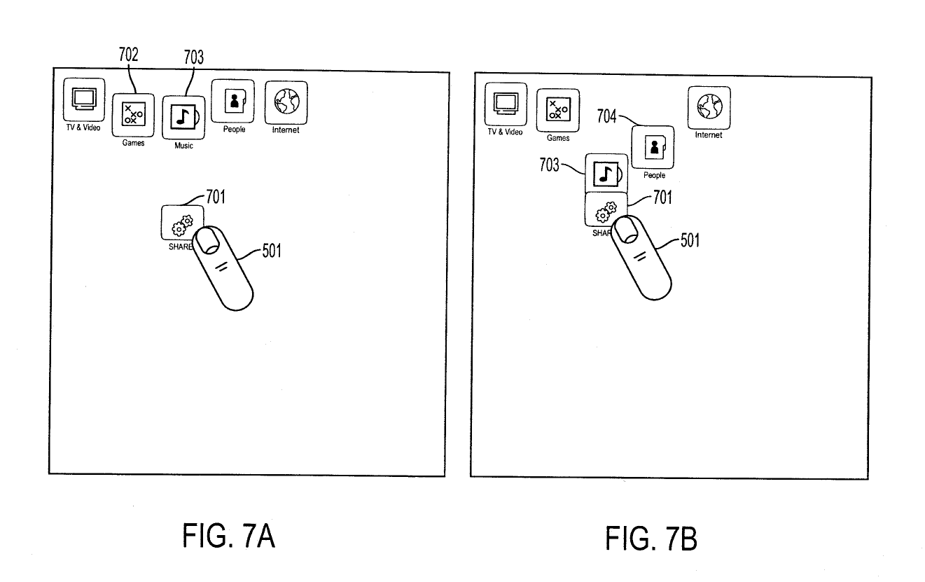

In one embodiment, dragging and dropping one object onto another may result in the electronic device creating a new, single entity associated with the combined objects. Once created, the electronic device may thereafter return to Block 305 to identify one or more potential target objects that may be linked, or otherwise associated, with the new, combined entity. To illustrate, reference is made to FIGS. 7A and 7B, which provide one example of how two selected objects may be combined to form a single, combined entity. As shown in FIG. 7A, the user may select (e.g., using his or her finger 501) a “Share” graphical item 701 that is representative of the function or action of sharing objects with other individuals. In response to the user selecting the “Share” graphical item 701, the electronic device may have identified as potential target objects a group of games (represented by the “Games” graphical item 702) and a group of music files (represented by the “Music” graphical item 703) stored on the electronic device memory. As a result, the electronic device may have moved the graphical items 702 and 703 associated with these potential target objects to a location that is within a predefined distance from the “Share” graphical item 701.

If the user then drags the “Share” graphical item 701 to the “Music” graphical item 703, as shown in FIG. 7B, the electronic device (e.g., means, such as a processor operating on the electronic device) may create a new, single entity associated with the share function and the group of music files (i.e., representing the sharing of music files with other individuals). In one embodiment, in order to signify the desire to create the new, single entity associated with the two objects, the user may drop the first object (e.g., the share function) onto the second object (e.g., the music files) by releasing, or unselecting, the first object. Alternatively, the user may hover over the second object, while continuing to select or hold the first object, for some predetermined period of time. Once the new, single entity associated with the two objects has been created, the electronic device may return to Block 305 in order to identify another one or more potential target objects that may be linked or associated with the new, combined entity. For example the electronic device (e.g., means, such as a processor) may identify the user's list of contacts as a potential target object, wherein dragging the combined share and music objects to the contact list may result in launching an application that would allow the user to select a music file to transmit to one or more of his or her friends or family members via a message addressed to an address stored in his or her contact list. Once identified, as shown in FIG. 7B, the electronic device may move the “People” graphical item 704, which is associated with the user's contact list, to a location that is closer to the combined “Share” and “Music” graphical items 701 and 703.

While not shown, in another embodiment, the user may select more than one graphical item at one time using, for example, multiple fingers or other selection devices in association with a touchscreen. In this embodiment, the electronic device may, at Block 304, identify potential target objects associated with each of the selected objects. Alternatively, the electronic device may identify only those potential target objects that are associated with all of the selected objects (e.g., only those that are capable of being linked to all of the selected objects). In either embodiment, the electronic device may thereafter cause the potential target graphical items to be displayed at a location that is close to any or all of the selected graphical items.

In yet another embodiment, the foregoing process may be used in relation to the selection of a hard key on an electronic device keypad, as opposed to the selection of a graphical item displayed on the electronic device display screen. In particular, according to one embodiment, the user may select an object by actuating a hard key on the electronic device keypad that is associated with that object. In response, the electronic device (e.g., means, such as a processor and, in one embodiment, the potential target object identification module) may, as described above, identify one or more potential target objects associated with the selected object. Once identified, instead of displaying the graphical items associated with the potential target objects within a predefined distance from a graphical item associated with the selected object, the electronic device (e.g., means, such as a processor and, in one embodiment, the repositioning module) may display the potential target graphical objects(s) within a predefined distance from the actuated hard key. This may be, for example, along an edge of the electronic device display screen nearest the electronic device keypad.

### Conclusion:

As described above and as will be appreciated by one skilled in the art, embodiments of the present invention may be configured as an apparatus or method. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 110 discussed above with reference to FIG. 1 or processor 208 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 110 of FIG. 1, or processor 208 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising:
a processor configured to:
receive a selection of an object;
identify one or more potential target objects with which the selected object is linkable; and
alter an image on a display screen so as to cause a graphical item associated with at least one of the one or more identified potential target objects to be displayed within a predefined distance from a first location at which either a graphical item associated with the selected object is displayed within the image or a key associated with the selected object is located within a keypad of the apparatus.

2. The apparatus of claim 1 further comprising:
a touch sensitive input device in electronic communication with the processor.

3. The apparatus of claim 2, wherein in order to receive a selection of an object having a corresponding graphical item displayed at a first location within an image on the display screen, the processor is further configured to:
detect a tactile input at the first location on the touch sensitive input device.

4. The apparatus of claim 3, wherein the processor is further configured to:
detect a movement of the tactile input from the first location in a first direction, wherein the processor is configured to identify the one or more potential target objects with which the selected object is linkable in response to detecting the movement of the tactile input.

5. The apparatus of claim 1, wherein in order to identify one or more potential target objects, the processor is further configured to:
access a look up table comprising a mapping of respective objects of a plurality of objects to one or more potential target objects with which the object is linkable.

6. The apparatus of claim 4, wherein in order to identify one or more potential target objects, the processor is further configured to:
identify one or more objects having a corresponding one or more graphical items displayed on the display screen, wherein respective graphical items are displayed at a location that is in the first direction relative to the first location at which the graphical item associated with the selected object is displayed.

7. The apparatus of claim 1, wherein the processor is further configured to:
prioritize the one or more identified potential target objects.

8. The apparatus of claim 7, wherein in order to prioritize the one or more identified potential target objects, the processor is further configured to:
determine, for respective identified potential target objects, a probability that the selected object will be linked to the identified potential target object.

9. The apparatus of claim 8, wherein the probability is determined based at least in part on a number of times the selected object has been linked to the identified potential target object in the past.

10. The apparatus of claim 8, wherein the probability is determined based at least in part on the direction of a location at which a graphical item associated with the identified potential target object is displayed relative to the first location at which the graphical item associated with the selected object is displayed.

11. The apparatus of claim 7, wherein in order to alter the image so as to cause a graphical item associated with at least one of the one or more identified potential target objects to be displayed within a predefined distance from the first location, the processor is further configured to:
cause a first graphical item associated with a first identified potential target object to be displayed within a first predefined distance from the first location; and
cause a second graphical item associated with a second identified potential target object to be displayed within a second predefined distance from the first location, wherein the first and second predefined distances are determined based at least in part on a relative priority associated with the first and second identified potential target objects, respectively.

12. The apparatus of claim 1, wherein the graphical item associated with the at least one of the one or more identified potential target objects was previously displayed at a second location within the image on the display screen, and wherein in order to alter the image so as to cause the graphical item to be displayed within a predefined distance from the first location, the processor is further configured to:
translate the previously displayed graphical item from the second location to a third location, wherein the third location is closer to the first location than the second location was to the first location.

13. The apparatus of claim 1, wherein the graphical item associated with the at least one of the one or more identified potential target objects was previously displayed at a second location within the image on the display screen, and wherein in order to alter the image so as to cause the graphical item to be displayed within a predefined distance from the first location, the processor is further configured to:
cause the graphical item associated with the at least one of the one or more identified potential target objects to be enlarged.

14. The apparatus of claim 1, wherein the graphical item associated with the at least one of the one or more identified potential target objects was not previously displayed on the display screen, and wherein in order to alter the image so as to cause the graphical item to be displayed within a predefined distance from the first location, the processor is further configured to:
generate and cause the graphical item to be displayed at a second location that is within the predefined distance from the first location.

15. The apparatus of claim 4, wherein the processor is further configured to:
detect a movement of the tactile input from the first location to a second location at which a graphical item associated with a target object is displayed; and
cause an action to be taken with respect to the selected and target objects.

16. A method comprising:
receiving a selection of an object;
identifying one or more potential target objects with which the selected object is linkable; and
altering an image on a display screen so as to cause a graphical item associated with at least one of the one or more identified potential target objects to be displayed within a predefined distance from the first location at which either a graphical item associated with the selected object is displayed within the image or a key associated with the selected object is located within a keypad.

17. The method of claim 16, wherein the display screen comprises a touch sensitive input device, and wherein receiving a selection of an object having a corresponding graphical item displayed at a first location within an image on the display screen further comprises:
detecting a tactile input at the first location on the touch sensitive input device.

18. The method of claim 17 further comprising:
detecting a movement of the tactile input from the first location in a first direction, wherein identifying the one or more potential target objects with which the selected object is linkable further comprises identifying the one or more potential target objects in response to detecting the movement of the tactile input.

19. The method of claim 16, wherein identifying one or more potential target objects further comprises:
accessing a look up table comprising a mapping of respective objects of a plurality of objects to one or more potential target objects with which the object is linkable.

20. The method of claim 18, wherein identifying one or more potential target objects further comprises:
identifying one or more objects having a corresponding one or more graphical items displayed on a display screen, wherein respective graphical items are displayed at a location that is in the first direction relative to the first location at which the graphical item associated with the selected object is displayed.

21. The method of claim 16 further comprising:
prioritizing the one or more identified potential target objects.

22. The method of claim 21, wherein altering the image so as to cause a graphical item associated with at least one of the one or more identified potential target objects to be displayed within a predefined distance from the first location further comprises:
causing a first graphical item associated with a first identified potential target object to be displayed within a first predefined distance from the first location; and
causing a second graphical item associated with a second identified potential target object to be displayed within a second predefined distance from the first location, wherein the first and second predefined distances are determined based at least in part on a relative priority associated with the first and second identified potential target objects, respectively.

23. The method of claim 16, wherein the graphical item associated with the at least one of the one or more identified potential target objects was previously displayed at a second location within the image on the display screen, and wherein altering the image so as to cause the graphical item to be displayed within a predefined distance from the first location further comprises:
translating the previously displayed graphical item from the second location to a third location, wherein the third location is closer to the first location than the second location was to the first location.

24. A computer program product comprising at least one computer-readable storage medium having computer-readable program code portions stored therein, the computer-readable program code portions comprising:
a first executable portion for receiving a selection of an object;
a second executable portion for identifying one or more potential target objects with which the selected object is linkable; and
a third executable portion for altering an image on a display screen so as to cause a graphical item associated with at least one of the one or more identified potential target objects to be displayed within a predefined distance from the first location at which either a graphical item associated with the selected object is displayed within the image or a key associated with the selected object is located within a keypad.

25. The computer program product of claim 24, wherein the display screen comprises a touch sensitive input device, and wherein the first executable portion is further configured to:
detect a tactile input at the first location on the touch sensitive input device.

26. The computer program product of claim 25 further comprising:
a fourth executable portion for detecting a movement of the tactile input from the first location in a first direction, wherein the second executable portion is further configured to identify the one or more potential target objects in response to detecting the movement of the tactile input.

27. The computer program product of claim 24, wherein the computer-readable program code portions further comprise:
a fourth executable portion for prioritizing the one or more identified potential target objects.

28. The computer program product of claim 27, wherein the third executable portion is further configured to:
cause a first graphical item associated with a first identified potential target object to be displayed within a first predefined distance from the first location; and
cause a second graphical item associated with a second identified potential target object to be displayed within a second predefined distance from the first location, wherein the first and second predefined distances are determined based at least in part on a relative priority associated with the first and second identified potential target objects, respectively.

29. The computer program product of claim 24, wherein the graphical item associated with the at least one of the one or more identified potential target objects was previously displayed at a second location within the image on the display screen, and the third executable portion is further configured to:
translate the previously displayed graphical item from the second location to a third location, wherein the third location is closer to the first location than the second location was to the first location.

30. An apparatus comprising:
means for receiving a selection of an object;
means for identifying one or more potential target objects with which the selected object is linkable; and
means for altering an image on a display screen so as to cause a graphical item associated with at least one of the one or more identified potential target objects to be displayed within a predefined distance from the first location at which either a graphical item associated with the selected object is displayed within the image or a key associated with the selected object is located within a keypad of the apparatus.
